(19) United States
(12) Patent Application Publication
(10) Pub. No.: US 2024/0064086 A1
(43) Pub. Date: Feb. 22, 2024

(54) SYSTEM AND METHODS FOR DYNAMIC ORCHESTRATION OF DEEP PACKET INSPECTION PROBES

(71) Applicant: Verizon Patent and Licensing Inc., Basking Ridge, NJ (US)

(72) Inventors: Syed Rehman, Monmouth Junction, NJ (US); Radhika Korlapati, Hyderabad (IN)

(21) Appl. No.: 18/047,334

(22) Filed: Oct. 18, 2022

(30) Foreign Application Priority Data
Aug. 22, 2022 (IN) 202241047611

(51) Int. Cl. H04L 43/12; H04L 43/028; H04L 41/0604

(52) U.S. Cl. CPC H04L 43/12; H04L 43/028; H04L 41/0604

(57) ABSTRACT

Systems and methods described herein provide dynamic orchestration of deep packet inspection (DPI) probes in a transport network. A network device receives an event report for a critical severity event in a network and stores the event report with other event reports to form an event data set. The network device correlates the event data set with a monitoring condition and selects a workflow for a DPI probe deployment that corresponds to the monitoring condition. The network device sends, to a service orchestrator device, a call to deploy a DPI probe in the network based on the workflow.

### CROSS-REFERENCE TO RELATED APPLICATION

This application claims priority to Indian Provisional Application No. 202241047611, filed Aug. 22, 2022, the disclosure of which is hereby incorporated by reference herein.

### BACKGROUND

An increasing number of virtual network functions (VNFs) use deep packet inspection (DPI) to perform advanced analysis and processing of packets for a variety of use cases, such as vulnerability exploit detection, policy enforcement, application-aware routing, traffic optimization, or other types of network-related services.

### BRIEF DESCRIPTION OF THE DRAWINGS

FIG. 1 is a diagram that depicts an example of a network environment in which systems and methods described herein may be implemented;

FIG. 2 is a diagram illustrating exemplary components of a network in the context of a deep packet inspection (DPI) probe orchestration service, according to an implementation described herein;

FIG. 3 is a diagram of example components of a device according to an implementation described herein;

FIG. 4 is a flow diagram illustrating a process for closed loop communications to implement a DPI probe orchestration service; and

FIGS. 5A and 5B illustrate a process flow for a use case of the DPI probe orchestration service, according to an implementation described herein.

### DETAILED DESCRIPTION OF EXAMPLE EMBODIMENTS

The following detailed description refers to the accompanying drawings. The same reference numbers in different drawings may identify the same or similar elements. Also, the following detailed description does not limit the invention.

A network service chain may include multiple virtual network functions in which traffic output from a virtual network function is input to another virtual network function of the service chain. The virtual network functions may include a probe to perform deep packet inspections (referred to herein as a DPI probe). A DPI probe may include an application for troubleshooting network failures. The DPI probe may capture network traces and provide an interface for users to inspect data on a packet level or a session level.

Each performance of deep packet inspection is time consuming and resource intensive as each individual packet is read, data is stored, and the data is processed. This inspection process may involve the use of various hardware resources (e.g., a processor, a memory, a storage, communication interface, etc.), virtualization elements (e.g., a hypervisor, a container, etc.), and other elements (e.g., an operating system, etc.). Regardless of the virtualization architecture used, such as a hypervisor-based architecture or a container-based architecture, repeated deep packet inspection operations performed by each virtual network function of the service chain, for each packet, results in inefficient use of resources (e.g., physical, virtual, logical) used by each virtual network function. DPI probes typically run continually, even when not required, resulting in further inefficient use of compute and storage resources. Furthermore, use of DPI probes may impose a significant licensing cost. Therefore, DPI probes may typically be deployed only at critical core interfaces in a network.

Currently, there is no mechanism for dynamically optimizing the use of DPI probes. Systems and methods described herein provide a DPI probe orchestration service. The DPI probe orchestration service may provide dynamic orchestration of DPI probes for efficient use of compute and storage resources, as well as reduced licensing costs. The systems and methods may automate the process of identifying critical failures at specific regions of a network using generated events and triggering a service orchestrator to deploy the respective DPI probes on time. The systems and methods may continue to observe the condition of network functions, again by using the generated events, until the problem is rectified. Once the problem is rectified, the service orchestrator may be triggered to undeploy (or uninstall) the respective DPI probes, thus eliminating unnecessary licensing costs.

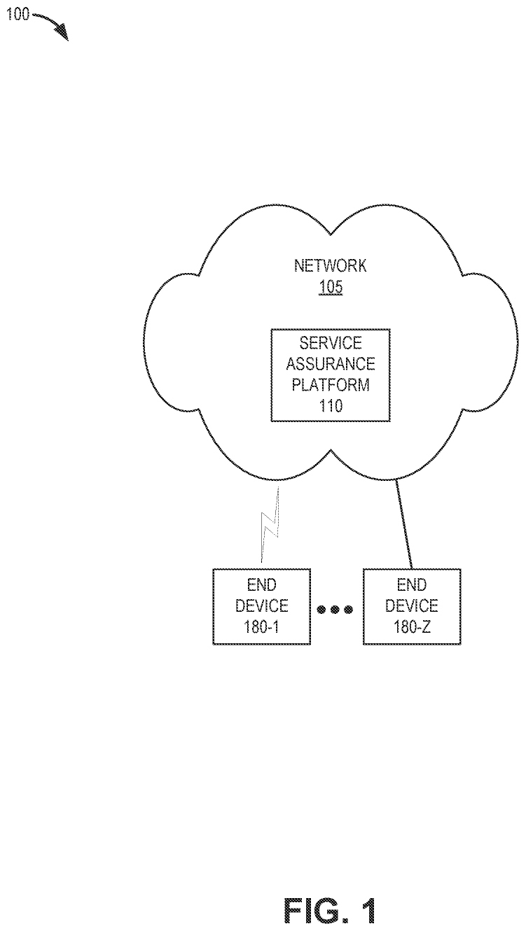

FIG. 1 is a diagram illustrating an example environment 100 in which an embodiment of the DPI probe orchestration service may be implemented. As illustrated, environment 100 includes a network 105. Network 105 includes a service assurance platform 110. Environment 100 further includes end devices 180-1 through 108-Z (referred to collectively as end devices 180 and individually (or generally) as end device 180). The number, type, and arrangement of network 105, as illustrated and described herein are exemplary. The number, the type, and the arrangement of service assurance platform 110 and end devices 180, as illustrated and described herein are also exemplary.

Environment 100 includes communication links within network 105 and between end devices 180 and network 105. Environment 100 may be implemented to include wired, optical, and/or wireless communication links. A communicative connection via a communication link may be direct or indirect. For example, an indirect communicative connection may involve an intermediary device and/or an intermediary network not illustrated in FIG. 1. A direct communicative connection may not involve an intermediary device and/or an intermediary network. The number and the arrangement of communication links illustrated in environment 100 are exemplary.

Network 105 may include one or multiple networks of one or multiple types and technologies. For example, network 105 may include an access network, a core network, a radio access network, an external network, an application service layer network, a back-haul network, a local area network, a metropolitan area network, a wide area network, a data network, the Internet, a public network, a private network, a wireless network, a wired network, an optical network, a mobile network, a cloud network, a packet-switched network, a data center, a service provider network, a mobile or multi-access edge computing (MEC) network, a fog network, an Ethernet network, and/or another type of network.

Service assurance platform 110 includes one or more network devices that provide the DPI probe orchestration service. As described further herein, service assurance platform 110 may automate the process of identifying critical failures at specific regions of network 105 using generated events and triggering a service orchestrator to dynamically deploy relevant DPI probes in the specific regions. The deployed DPI probes may provide packet data that can be used by other network services to remedy the critical failures. Service assurance platform 110 may also identify when critical failures have been resolved and automatically trigger the service orchestrator to dynamically undeploy the DPI probes.

End device 180 includes a device that has computational and communication capabilities (e.g., wireless, wired, optical, etc.). End device 180 may be implemented as a mobile device, a portable device, a stationary device, a device operated by a user, or a device not operated by a user. For example, end device 180 may be implemented as a Mobile Broadband device, a smartphone, a computer, a tablet, a netbook, a phablet, a wearable device, a vehicle support system, a game system, a global positioning device, a drone, customer premise equipment (CPE) (e.g., a set top box, etc.), a television, a streaming player device, an Internet of Things (IoT) device, or some other type of wireless, wired, and/or optical device. According to various exemplary embodiments, end device 180 may be configured to execute various types of software (e.g., applications, programs, etc.). The number and the types of software may vary among end devices 180. End device 180 may generate and transmit packets via network 105. Additionally, or alternatively, end device 180 may receive packets via network 105.

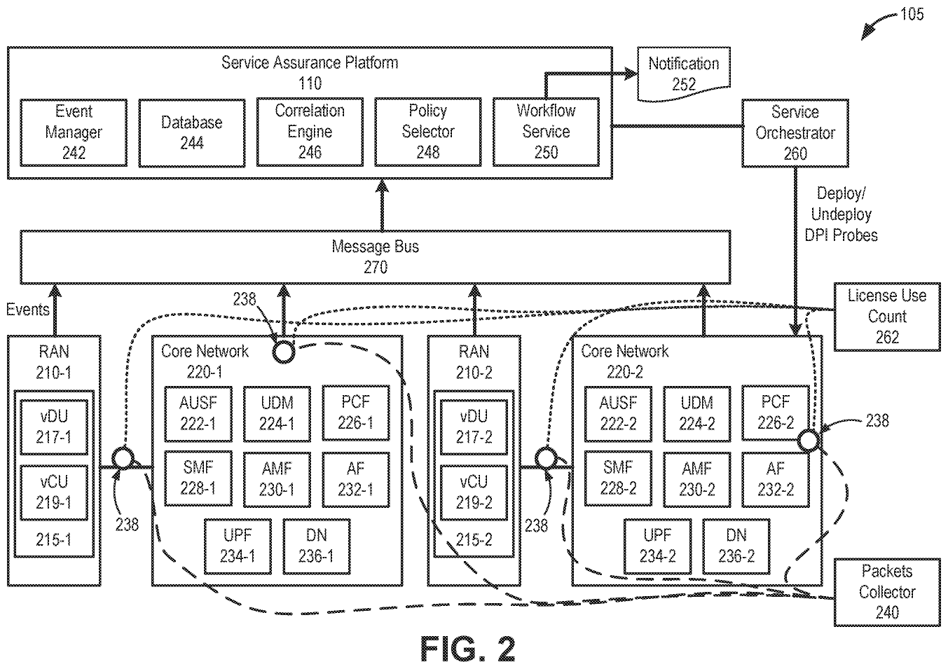

FIG. 2 is a diagram illustrating exemplary components of network 105 in the context of DPI probe orchestration service, according to an implementation described herein. As shown in FIG. 2, network 105 may include service assurance platform 110, radio access networks (RANs) 210-1 and 210-2 (referred to generically as RAN 210), core networks 220-1 and 220-2 (referred to generically as core network 220), a service orchestrator 260, and a message bus 270. RANs 210 and core networks 220 may be collectively referred to herein as a traffic network. While FIG. 2 depicts a one or two instances of some network functions in network 105 for illustration purposes, in practice, there may be multiple other instances of one or more network functions.

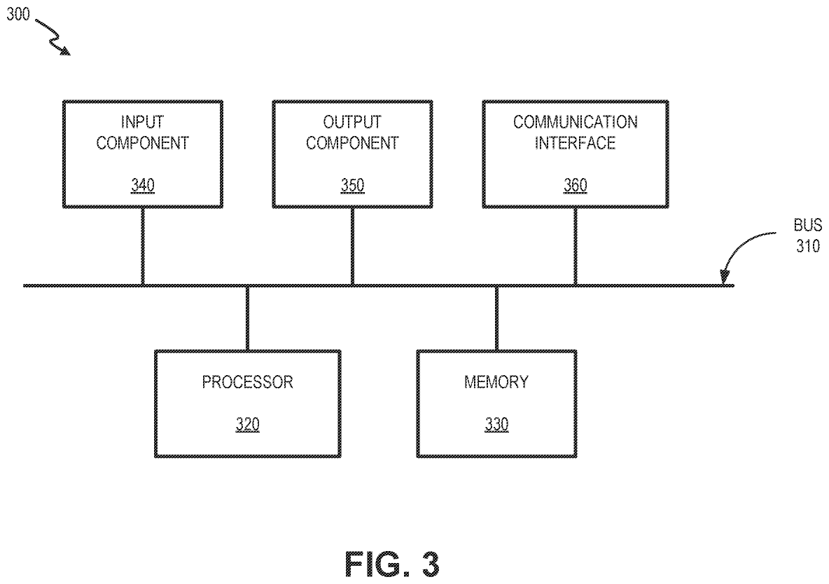

The components depicted in FIG. 2 may be implemented as dedicated hardware components or as virtualized functions implemented on top of a common shared physical infrastructure using software defined networking (SDN). For example, an orchestration platform may implement one or more of the components of FIG. 2 using an adapter implementing a virtualized network function (VNF) virtual machine, a containerized network function (CNF) container, an event driven serverless architecture interface, and/or another type of SDN architecture. The common shared physical infrastructure may be implemented using one or more devices 300 described below with reference to FIG. 3.

Referring to FIG. 2, RAN 210 may enable end devices (e.g., end devices 180, not shown) to connect to core network 220 for mobile telephone service, Short Message Service (SMS), Multimedia Message Service (MMS), Internet access, cloud computing, and/or other types of data services. RAN 210 may include wireless access stations 215 that service end devices within a geographic area. Wireless access station 215 may include a 5G base station (e.g., a gNodeB or gNB) that includes one or more radio frequency (RF) transceivers configured to send and receive 5G NR wireless signals. According to an implementation, a wireless access station 215 may include a gNB or its equivalent with multiple distributed components, such as a virtualized central unit (vCU) 217, a virtualized distributed unit (vDU) 219, a remote unit (RU or a remote radio unit (RRU)), or another type of component to support distributed arrangements. Furthermore, in some implementations, wireless access station 215 may include a Multi-Access Edge Computing (MEC) system that performs cloud computing and/or provides network processing services for end devices 180.

Core network 220 may manage communication sessions for end devices. For example, core network 220 may provide mobility management, session management, authentication, and packet transport, to support wireless communication services. Core network 220 may be compatible with known wireless standards which may include, for example, 3GPP 5G (non-standalone (NSA) and standalone (SA)), Long Term Evolution (LTE), LTE Advanced, etc. Core network 220 may include various types of network devices, which may implement different network functions described further herein. As shown in FIG. 2, components of core network 220 may include an Authentication Server Function (AUSF) 222, a Unified Data Management (UDM) 224, a Policy Control Function (PCF) 226, a Session Management Function (SMF) 228, an Access and mobility Management Function (AMF) 230, an Application Function (AF) 232, and a User Plane Function (UPF) 234. In some implementations, core network 220 may also include a Data Network (DN) 236. In other implementations, DN 236 may be a separate network from core network 220.

Each of vDU 217, vCU 219, AUSF 222, UDM 224, PCF 226, SMF 228, AMF 230, AF 232, UPF 234, and DN 236 may generate event messages that are published to message bus 270. Particularly, according to implementations described herein, these network functions in RAN 210 and/or core network 220 may publish to message bus 270 “critical,” “major,” or “clear” events. Critical events and major events may be referred to generically herein as “critical severity events.” A critical severity event may include an event designated by a network function under the “critical” or “major” event topic for message bus 270. Critical severity events may include alarms, alert notices, or other indicators pointing to a network disruption or failure.

DPI probe 238 may be deployed in a network device to provide deep packet inspection, as described herein. According to various exemplary embodiments, DPI probe 238 may reside in one or multiple networks of network 105 (e.g., RANs 210, core networks 220, etc.). According to an embodiment, DPI probe 238 is included in a virtual network device. According to an exemplary embodiment, the virtual network device includes a primary agent and a secondary agent (e.g., a DPI probe) that provides packet inspections. DPI probe 238 may capture network traces and provides an interface to inspect data on a packet or session level. According to implementations described herein, DPI probes 238 may be selectively and dynamically deployed throughout RAN 210 and core network 220. Packet data obtained by DPI probes 238 may be provided to packets collector 240, where it may be used by network management systems to analyze and resolve network failures.

Service assurance platform 110 may include components to implement the DPI probe orchestration service. For example, service assurance platform 110 may automate the process of identifying critical failures at specific regions of network 105 using generated events and triggering service orchestrator 260 to dynamically deploy relevant DPI probes 238. Service assurance platform 110 may further continue to observe the condition of the network functions monitored by the DPI probes (e.g., using the generated events) until the failure is resolved. When a failure is resolved, service assurance platform 110 may trigger the service orchestrator 260 to undeploy the DPI probes 238. As shown in FIG. 2, service assurance platform 110 may include an event manager 242, a database 244, a correlation engine 246, a policy selector 248, and a workflow service 250.

Event manager 242 may collect from message bus 270 any event topics to which service assurance platform 110 is subscribed (e.g., critical severity events). Event manager 242 may normalize the events (e.g., provide a uniform presentation of data elements from different types of devices) and save the normalized events and/or raw event messages into events database 244.

Database 244 may include a memory (e.g., memory 330 described below) to store events (e.g., critical severity events) obtained by event manager 242 and make them accessible to correlation engine 246. As new events are received, they may be added to other stored events and compiled as an event data set.

Correlation engine 246 may aggregate collected events in database 244 by proximity, time, or other conditions. Correlation engine 246 may attempt to match the collected events to certain conditions (e.g., conditions that indicate the presence/absence of different types of network faults, negative trends, etc.). If a condition is triggered, correlation engine 246 may forward the condition to policy selector 248.

Policy selector 248 may determine which of multiple workflow services are to be executed based on the condition identified by correlation engine 246. For example, policy selector 248 may store policies that identify monitoring plans for different network conditions. The policies may identity types of interfaces and/or network functions to monitor for different conditions. The policies may further identity particular features of DPI probes needed to perform the monitoring. Policy selector 248 may select, based on the identified condition, an appropriate policy to implement a dynamic DPI deployment.

Workflow service 250 may execute closed loop workflows in response to an identified condition. The closed loop workflows may include a series of actions relevant to deploying DPI probes 238 for analyzing the particular condition. Based on a particular workflow, for example, workflow service 250 may fetch details such as a network location (e.g., Region, Cluster, Namespace, etc.) and an expected type of DPI probe 238 to be deployed. Workflow service 250 may trigger service orchestrator 260 with these deployment details. According to an implementation, workflow service 250 may also generate a notification 252, such as an email or text message, to inform a network administrator of the DPI probe deployments.

Service orchestrator 260 may include service orchestration logic to manage the provisioning and/or configuration of network devices in RAN 210 and core network 220. In some implementations, service orchestrator 260 may be included within a service management platform that provides orchestration at a high level, with an end-to-end view of the infrastructure, networks (e.g., access network 210 and core network 220), and applications. In other implementations, service orchestrator 260 may include additional functions/components, such as an element management system (EMS), a service design and creation (SDC) function, a run-time service orchestrator (RSO), and an active and available inventory (AAI) function. According to an implementation, service orchestrator 260 may automate sequences of activities, tasks, rules, and policies needed for on-demand deployment, modification, or removal of DPI probes 238. Service orchestrator 260 may direct deployment, instantiation, scaling, updating, and/or termination of DPI probes 238 (on their hosting network devices or virtual network functions) based on instructions received from service assurance platform 110. In one implementation, a current level of deployed DPI probe 238 instances may be tracked at license counter 262, which may be updated with each deployment or un-deployment of DPI probes 238.

Message bus 270 may include data streaming technology to provide data from RAN 210 and/or core network 220 to service assurance platform 110. The data may include event messages (e.g., for critical severity events) generated by vDU 217, vCU 219, AUSF 222, UDM 224, PCF 226, SMF 228, AMF 230, AF 232, UPF 234, DN 236, or another network function. Message bus 270 may support, for example, a publish-subscribe (pub-sub) model. According to an implementation, message bus 270 may include a distributed streaming platform that publishes streams of records from producers/contributors (e.g., in RAN 210 and core network 220) to consumers (e.g., service assurance platform 110), stores the streams of records in a fault-tolerant durable manner, and processes the streams of records. For example, a PCF 226 may publish a critical severity event to message bus 270 for distribution to service assurance platform 110.

Message bus 270 may be implemented using a Pulsar bus, a Kafka bus, or another type of data bus, and contributors may contribute a stream of records to one or more topics on message bus 270. According to an implementation, message bus 270 may be configured with one or more partitioned topics specific to critical severity events (e.g., “critical” events and “major” events). In one aspect, the critical severity events topic(s) may be configured to have maximum data retention policy associated with the message bus settings (e.g., to avoid data loss). Service assurance platform 110 may subscribe to the critical severity events topics and retrieve records of subscribed topics for consumption.

Although FIG. 2 shows certain components of network 105, in other implementations, network 105 may include fewer components, different components, differently arranged components, or additional components than depicted in FIG. 2. For example, although not illustrated in FIG. 2, core network 220 may include other network functions, such as a Charging Enablement Function (CEF), a Network Repository Function (NRF), a Network Slice Selection Function (NSSF), a Network Slice Selection Function (NSSF), a Network Data Analytics Function (NWDAF), etc. As another example, a network management system may be included to resolve network errors, service disruptions, etc., such as those indicated with the critical severity event topic in message bus 270. Additionally, or alternatively, one or more components of network 105 may perform functions described as being performed by one or more other components of network 105.

FIG. 3 illustrates example components of a device 300 according to an implementation described herein. Components of service assurance platform 110, end device 180, wireless access station 215, vDU 117, vCU 119, AUSF 222, UDM 224, PCF 226, SMF 228, AMF 230, AF 232, UPF 234, DN 236, DPI probes 238 and service orchestrator 260 may each include or be implemented on one or more devices 300. Device 300 may include a bus 310, a processor 320, a memory 330, an input component 340, an output component 350, and a communication interface 360.

Bus 310 may include a path that permits communication among the components of device 300. Processor 320 may include a processor, a microprocessor, or processing logic that may interpret and execute instructions. Memory 330 may include any type of dynamic storage device that may store information and instructions, for execution by processor 320, and/or any type of non-volatile storage device that may store information for use by processor 320. Input component 340 may include a mechanism that permits a user to input information to device 300, such as a keyboard, a keypad, a button, a switch, etc. Output component 350 may include a mechanism that outputs information to the user, such as a display, a speaker, one or more light emitting diodes (LEDs), etc.

Communication interface 360 may include a transceiver that enables device 300 to communicate with other devices and/or systems via wireless communications, wired communications, or a combination of wireless and wired communications. For example, communication interface 360 may include mechanisms for communicating with another device or system via a network. Communication interface 360 may include an antenna assembly for transmission and/or reception of RF signals. For example, communication interface 360 may include one or more antennas to transmit and/or receive RF signals over the air. In one implementation, for example, communication interface 360 may communicate with a network and/or devices connected to a network. Alternatively, or additionally, communication interface 360 may be a logical component that includes input and output ports, input and output systems, and/or other input and output components that facilitate the transmission of data to other devices.

Device 300 may perform certain operations in response to processor 320 executing software instructions contained in a computer-readable medium, such as memory 330. A computer-readable medium may be defined as a non-transitory memory device. A memory device may include space within a single physical memory device or spread across multiple physical memory devices. The software instructions may be read into memory 330 from another computer-readable medium or from another device. The software instructions contained in memory 330 may cause processor 320 to perform processes described herein. Alternatively, hardwired circuitry may be used in place of or in combination with software instructions to implement processes described herein. Thus, implementations described herein are not limited to any specific combination of hardware circuitry and software.

Although FIG. 3 shows exemplary components of device 300, in other implementations, device 300 may contain fewer components, additional components, different components, or differently arranged components than those depicted in FIG. 3. For example, device 300 may include one or more switch fabrics instead of, or in addition to, bus 310. Additionally, or alternatively, one or more components of device 300 may perform one or more tasks described as being performed by one or more other components of device 300.

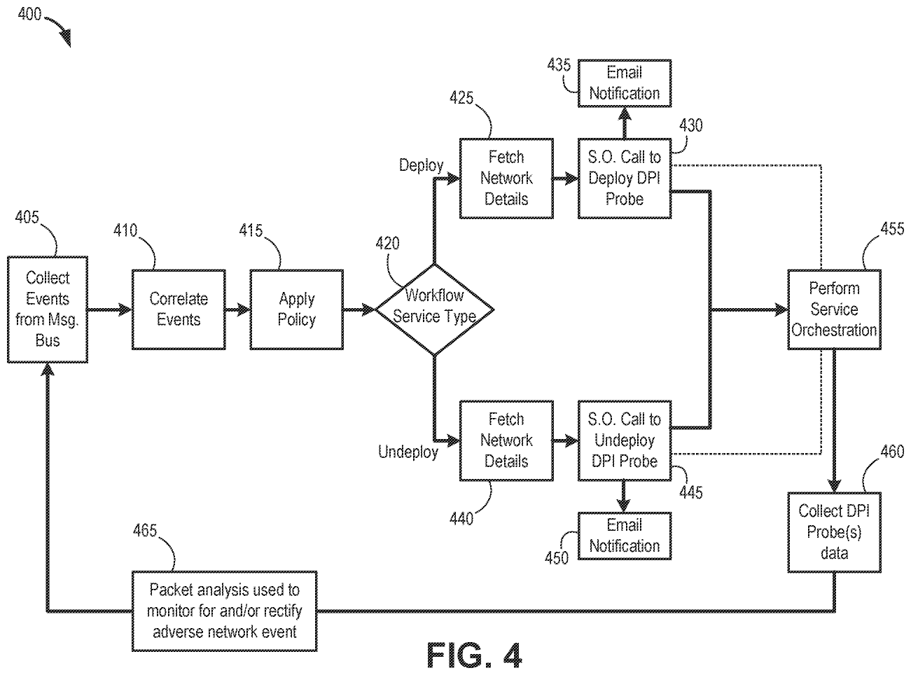

FIG. 4 is a flow diagram illustrating a process 400 for closed loop communications to implement a DPI probe orchestration service. As shown in FIG. 4 at step 405, service assurance platform 110 (e.g., event manager 242) may collect events (e.g., critical severity events) from message bus 270. The events may be normalized and stored in database 244. At step 410, service assurance platform 110 (e.g., correlation engine 246) may correlate the events to determine if the events indicate a network condition where DPI deployment/undeployment is warranted. In step 415, service assurance platform 110 (e.g., policy selector 248) may select and apply an appropriate workflow for dynamically deploying DPI probes to monitor the network condition or for dynamically undeploying DPI probes to cease monitoring a resolved network condition.

At step 420, service assurance platform 110 may activate the workflow service. Assuming a network condition requires a DPI deployment, at step 425, service assurance platform 110 (e.g., workflow service 250) may fetch network details that can be applied to enable the DPI deployment. For example, workflow service 250 may determine a particular deployment location (e.g., region, cluster, namespace, tenant space, etc.) and type of DPI probe to perform the monitoring. At step 430, service assurance platform 110 (e.g., workflow service 250) may use the network details to generate and send instructions (e.g., an API call to service orchestrator 260) to perform the DPI probe deployment. At step 435, service assurance platform 110 (e.g., workflow service 250) may send a notification about the DPI probe deployment to an appropriate network technician (e.g., a respective network function/platform owner). According to an implementation, workflow service 250 may receive feedback/confirmation from service orchestrator 260 about the DPI probe deployment, which may be included with the notification message.

Returning to step 420, service assurance platform 110 may alternatively activate the workflow service for a DPI undeployment. At step 440, service assurance platform 110 (e.g., workflow service 250) may fetch network details to disable a deployment. For example, workflow service 250 may identify particular DPI probes that are no longer needed to perform network monitoring. At step 445, service assurance platform 110 (e.g., workflow service 250) may use the identified DPI probes to generate and send instructions (e.g., an API call to service orchestrator 260) to remove the DPI probe deployment. At step 450, service assurance platform 110 (e.g., workflow service 250) may send a notification about the DPI probe undeployment to the appropriate network technician (e.g., a respective network function/platform owner). According to an implementation, workflow service 250 may receive feedback/confirmation from service orchestrator 260 about the DPI probe undeployment, which may be included with the notification message.

At step 455, service orchestrator 260 may receive the deployment/undeployment instructions from service assurance platform 110 and perform required service orchestration. For example, service orchestrator 260 may fetch from a data store a DPI probe image (e.g., an application software image) for a designated DPI probe 238 and deploy the image on the appropriate network function in the respective locations. At step 460, the DPI probes 238 deployed in the designated locations may perform packet inspections and collect packet inspection data. At step 465, network tools and/or a network administrator may use the packet inspection data to monitor for and/or resolve an adverse network event. During the DPI probe monitoring, network functions in RAN 210 and/or core network 220 can continue to submit critical severity events to message bus 270. For example, event reporting from individual network functions may occur independently from DPI probe monitoring.

When network problems are resolved, the network functions in the respective regions where DPI probes 238 are deployed will eventually emit “clear” event or resolved signal for the critical severity events, which may be posted to message bus 270. Thus, in the closed loop process 400 the DPI probe orchestration service may continue to collect events from message bus 270 (step 405) and repeat the process to dynamically update (e.g., deploy or undeploy) DPI probe 238 instances.

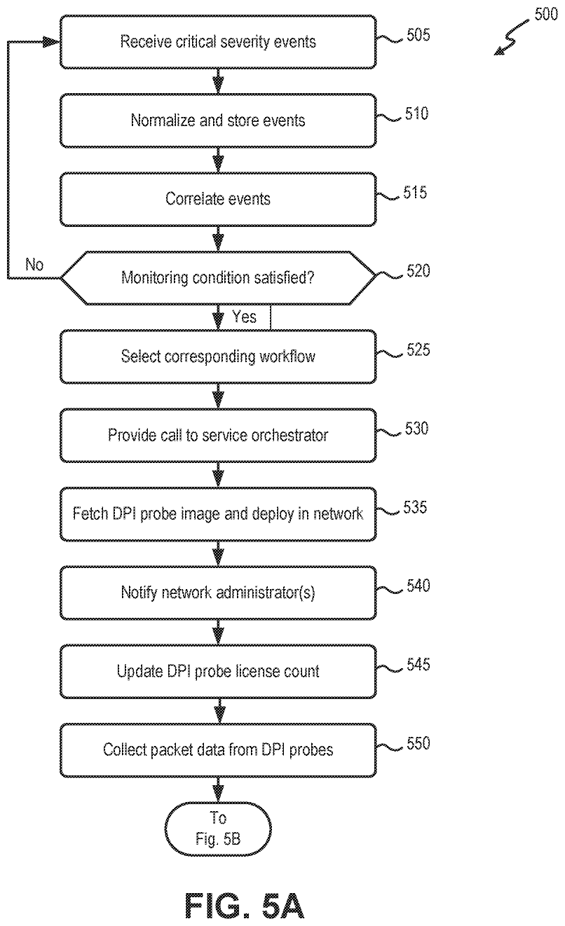

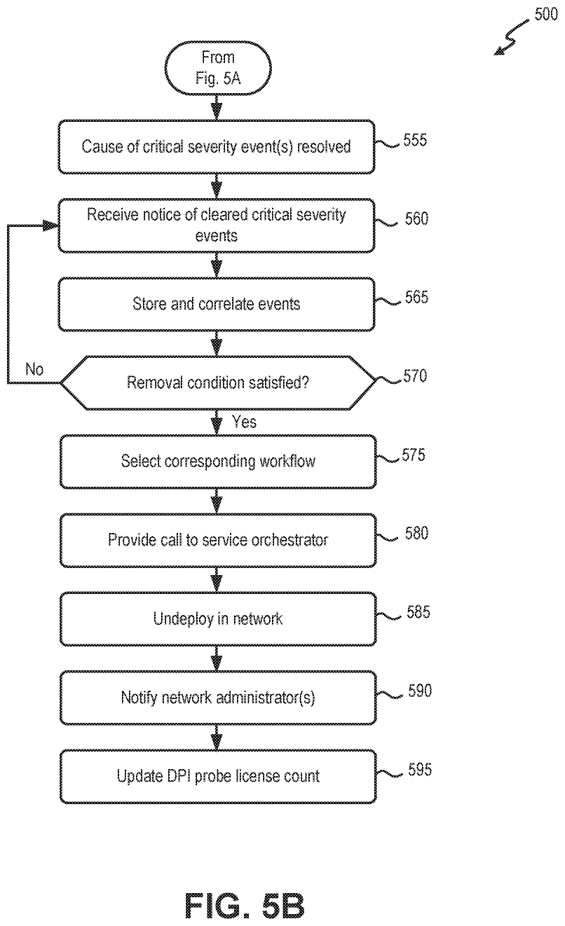

FIGS. 5A and 5B illustrate a process flow 500 for a particular use case of the DPI probe orchestration service. Process flow 500 may be implemented in network environment 100 including network 105 of FIG. 2.

Referring to FIG. 5A, process 500 may include observing critical severity events (block 505). For example, network functions in RANs 210-1/210-2 and core networks 220-1 and 220-2 may report events to message bus 270. Event manager 242 may observe the critical severity events generated by specific network functions in RANs 210 and core networks 220 which are published on message bus 270. In the example of FIG. 1, assume critical severity events (e.g., alarms, etc.) may be generated by network functions in RAN 210-1 (vCU 219-1), core network 220-1 (SMF 228-1), RAN 210-2 (vCU 219-2), and core network 220-2 (PCF 226-2 and AF 219-2).

Process 500 may further include normalizing and storing the critical severity events (block 510), correlating the events (block 515), and determining if a monitoring condition is satisfied (520). For example, event manager 242 may normalize the critical severity events obtained from message bus 270, such as formatting alarm data of network functions from different vendors into a consistent format. Event manager 242 may store the normalized events in database 244. Correlation engine 246 may review the specific critical severity events at regular intervals of time and correlates the events, based on certain conditions (e.g., based on the number of alarms, timing, location, network impact, etc.).

If no monitoring condition is satisfied (block 520—no), service assurance platform 110 may return to block 505 and continue to receive critical severity events. If a monitoring condition is satisfied (block 520—yes), service assurance platform 110 may select a corresponding workflow service to deploy DPI probes (block 525). In the illustration of FIG. 2, assume correlation engine 246 correlates alarms from vCU 219-1, SMF 228-1, vCU 219-2, PCF 226-2, and AF 219-2 to trigger a monitoring condition. Policy selector 248 may select, based on the identified condition, an appropriate workflow to implement a dynamic DPI deployment.

Process 500 may further include providing a call to a service orchestrator (block 530). For example, workflow service 250 may fetch details for implementing the appropriate workflow (e.g., region, cluster, namespace, and expected type of DPI probe to be deployed) and trigger service orchestrator 260 (e.g., via an API call) with the details.

Process 500 may additionally include fetching the DPI probe image and deploying the DPI probe(s) to the network (block 535), notifying the network administrators of the deployment (block 540), update a licensing count (block 545), and collect data from DPI probes (block 550). For example, service orchestrator 260, in response to the API call from workflow service 250, may fetch the DPI Probe image and may deploy DPI probes 238 at the particular locations according to the workflow (e.g., as indicated by the location of DPI probes 238 in FIG. 2). Service orchestrator 260 may notify workflow service 250 of the DPI probe deployment (e.g., successful deployment, failure, etc.). In response to the notification from service orchestrator 260, workflow service 250 may send a notification (e.g., notification 252) about the deployment of DPI probes 238 to respective network function/platform owners, such as network administrators for one or more of vCU 219-1, SMF 228-1, vCU 219-2, PCF 226-2, and AF 219-2. Successfully deployment of each DPI probe 238 may be recorded at license counter 262 to accurately reflect the number of installed DPI probe instances in network 105. The deployed DPI probes 238 may begin collecting packet data, which may be pushed to packet collector 240 for further analysis.

Referring to FIG. 5B, the cause of the critical severity events may be resolved (block 555), and process 500 may further include receiving notice of the cleared critical severity events (block 560). For example, based on packets analysis from the DPI probe data, a network management system or team may rectify the problem. In response to the resolution, the network functions in the respective regions (e.g., vCU 219-1, SMF 228-1, vCU 219-2, PCF 226-2, and AF 219-2) may start emitting alarm updates with an indication of “clear.” The alarm updates may be published to message bus 270 and pushed to event manager 242.

Process 500 may further include storing and correlating the events (block 565) and determining if a removal condition is satisfied (570). For example, event manager 242 may store the notices of the cleared critical severity event in database 244. Correlation engine 246 may review the notices at regular intervals of time and correlates the notices with previously stored critical severity events to determine if the notices are indicative of a resolved network problem where DPI probes 238 have been deployed.

If a removal condition is not satisfied (block 570—no), service assurance platform 110 may return to block 560 and continue to receive notices of cleared critical severity events. If a monitoring condition is satisfied (block 570—yes), workflow service 250 may select a corresponding workflow to undeploy DPI probes (block 575). For example, policy selector 248 may select, based on the identified condition, an appropriate workflow to dynamically undeploy DPI probes 238.

Process 500 may further include providing a call to a service orchestrator (block 580), undeploying the DPI probe(s) from the network (block 585), notifying the network administrators of the removed DPI probes (block 590), and updating a licensing count (block 595). For example, workflow service 250 may fetch details for implementing the appropriate workflow (e.g., network addresses of DPI probe 238 to be undeployed) and trigger service orchestrator 260 (e.g., via an API call) with the details. Service orchestrator 260, in response to the API call from workflow service 250, may undeploy DPI probes 238 at the particular locations (e.g., as indicated by the location of DPI probes 238 in FIG. 2). Service orchestrator 260 may notify workflow service 250 of the DPI probe undeployment (e.g., successful removal, failure, etc.). In response to the notification from service orchestrator 260, workflow service 250 may send a notification (e.g., notification 252) about the removal of DPI probes 238 to respective network function/platform owners. Successful undeployment of each DPI probe 238 may be recorded at license counter 240 to accurately reflect the current number of installed DPI probe instances in network 105.

Systems and methods described herein provide dynamic orchestration of deep packet inspection (DPI) probes in a transport network. A network device receives a first event report for a critical severity event in a network and stores the first event report with other event reports to form an event data set. The network device correlates the event data set with a monitoring condition and selects a first workflow for a DPI probe deployment that corresponds to monitoring condition. The network device sends, to a service orchestrator device, a call to deploy a DPI probe in the network based on the first workflow. In some implementations, the network device receives a second event report that indicates the critical severity event in the network is cleared and determines, based on receiving the second event report, when a removal condition is satisfied. The network device selects a second workflow to remove the DPI probe; and sends, to the service orchestrator device, a call to initiate removal of the DPI probe in the network based on the second workflow.

The foregoing description of implementations provides illustration and description, but is not intended to be exhaustive or to limit the invention to the precise form disclosed. Modifications and variations are possible in light of the above teachings or may be acquired from practice of the invention. For example, while a series of blocks have been described with regard to FIGS. 5A-5B, and message/operation flows with respect to FIG. 4, the order of the blocks and message/operation flows may be modified in other embodiments. Further, non-dependent blocks may be performed in parallel.

Certain features described above may be implemented as “logic” or a “unit” that performs one or more functions. This logic or unit may include hardware, such as one or more processors, microprocessors, application specific integrated circuits, or field programmable gate arrays, software, or a combination of hardware and software.

As set forth in this description and illustrated by the drawings, reference is made to “an exemplary embodiment,” “an embodiment,” “embodiments,” etc., which may include a particular feature, structure or characteristic in connection with an embodiment(s). However, the use of the phrase or term “an embodiment,” “embodiments,” etc., in various places in the specification does not necessarily refer to all embodiments described, nor does it necessarily refer to the same embodiment, nor are separate or alternative embodiments necessarily mutually exclusive of other embodiment(s). The same applies to the term “implementation,” “implementations,” etc.

To the extent the aforementioned embodiments collect, store or employ personal information provided by individuals, it should be understood that such information shall be used in accordance with all applicable laws concerning protection of personal information. Additionally, the collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

Use of ordinal terms such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

No element, act, or instruction used in the description of the present application should be construed as critical or essential to the invention unless explicitly described as such. Also, as used herein, the article “a” is intended to include one or more items. Further, the phrase “based on” is intended to mean “based, at least in part, on” unless explicitly stated otherwise.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a network device, a first event report for a critical severity event in a network;
storing, by the network device, the first event report with other event reports to form an event data set;
correlating, by the network device, the event data set with a monitoring condition;
selecting, by the network device, a first workflow for a deep packet inspection (DPI) probe deployment that corresponds to the monitoring condition; and
sending, by the network device and to a service orchestrator device, a call to deploy a DPI probe in the network based on the first workflow.

2. The method of claim 1, further comprising:
deploying, by the service orchestrator device, the DPI probe in the network; and
updating a license count for the DPI probe in response to the deploying.

3. The method of claim 1, further comprising:
receiving, by the network device, a second event report that indicates the critical severity event in the network is cleared;
determining, by the network device and based on receiving the second event report, if a removal condition is satisfied;
selecting, by the network device, a second workflow to remove the DPI probe; and
sending, by the network device and to the service orchestrator device, a call to initiate removal of the DPI probe in the network based on the second workflow.

4. The method of claim 3, further comprising:
removing, by the service orchestrator device, the DPI probe; and
updating a license count for the DPI probe in response to the removing the DPI probe.

5. The method of claim 1, wherein the network is a traffic network, and wherein the network device is in a service assurance platform that is separate from the traffic network.

6. The method of claim 1, further comprising:
normalizing, by the network device, the first event report to conform with the other event reports.

7. The method of claim 1, further comprising:
fetching, by the service orchestrator device and in response to the call, a software image for the DPI probe; and
notifying, by the service orchestrator device, the network device of a successful DPI probe deployment.

8. The method of claim 1, wherein selecting the first workflow for the DPI probe deployment includes:
selecting the first workflow, from multiple stored workflows, based on the monitoring condition.

9. The method of claim 1, wherein sending the call to deploy the DPI probe includes:
sending a deployment location and a type of the DPI probe.

10. A system comprising:
a network device including processor configured to:
receive a first event report for a critical severity event in a network;
store the first event report with other event reports to form an event data set;
correlate the event data set with a monitoring condition;
select a first workflow for a deep packet inspection (DPI) probe deployment that corresponds to the monitoring condition; and
sending, to a service orchestrator device, a call to deploy a DPI probe in the network based on the first workflow.

11. The system of claim 10, wherein the processor of the network device is further configured to:
receive a second event report that indicates the critical severity event in the network is cleared;
determine, based on receiving the second event report, if a removal condition is satisfied;
select a second workflow to remove the DPI probe; and
send, to the service orchestrator device, a call to initiate removal of the DPI probe in the network based on the second workflow.

12. The system of claim 10, further comprising:
the service orchestrator device configured to:
remove the DPI probe from deployment in the network, and
update a license count for the DPI probe in response to the removing the DPI probe.

13. The system of claim 11, further comprising:
the service orchestrator device configured to:
deploy the DPI probe in the network, and
update a license count for the DPI probe in response to the deploying.

14. The system of claim 10, wherein the network include at least one radio access network (RAN) and at least one core network.

15. The system of claim 10, wherein, when receiving the first event report, the processor of the network device is further configured to:
receive the first event report via subscription a message bus topic.

16. The system of claim 10,
the service orchestrator device configured to:
fetch, in response to the call, a software image for the DPI probe; and
notify the network device of a successful DPI probe deployment.

17. The system of claim 10, wherein the call to deploy the DPI probe includes a deployment location and a type of the DPI probe.

18. A non-transitory computer-readable medium containing instructions, executable by at least one processor, for:
receiving, by a network device, a first event report for a critical severity event in a network;
storing, by the network device, the first event report with other event reports to form an event data set;
correlating, by the network device, the event data set with a monitoring condition;
selecting, by the network device, a first workflow for a deep packet inspection (DPI) probe deployment that corresponds to the monitoring condition; and
sending, by the network device and to a service orchestrator device, a call to deploy a DPI probe in the network based on the first workflow.

19. The non-transitory computer-readable medium claim 18, further comprising instructions for:
receiving, by the network device, a second event report that indicates the critical severity event in the network is cleared;
determining, by the network device and based on receiving the second event report, if a removal condition is satisfied; and
sending, by the network device and to the service orchestrator device, a call to initiate removal of the DPI probe in the network.

20. The non-transitory computer-readable medium claim 18, further comprising instructions for:
normalizing the first event report to conform with the other event reports.
